(19) United States
(12) Patent Application Publication
(10) Pub. No.: US 2023/0132644 A1
(43) Pub. Date: May 4, 2023

(54) TRACKING A HANDHELD DEVICE

(71) Applicant: Meta Platforms Technologies, LLC, Menlo Park, CA (US)

(72) Inventors: Andrew Melim, Seattle, WA (US); Hemanth Korrapati, Maple Valley, WA (US); Sheng Shen, Shoreline, WA (US); Howard Sun, Seattle, WA (US); Shangchen Han, Kirkland, WA (US)

(21) Appl. No.: 17/513,755

(22) Filed: Oct. 28, 2021

(51) Int. Cl. G06F 3/01; G06N 20/00; G06N 3/04; G02B 27/01; G06T 7/80; G06K 9/46; G02B 27/00; G06F 1/16

(52) U.S. Cl. CPC G06F 3/011; G02B 27/017; G02B 27/0093; G06F 1/1694; G06K 9/4661; G06N 3/0454; G06N 20/00; G06T 7/80

(57) ABSTRACT

In one embodiment, a method includes accessing an image comprising a handheld device, the image being captured by one or more cameras associated with the computing device, generating a cropped image that comprises a hand of a user or the handheld device from the image by processing the image using a first machine-learning model, generating a vision-based 6DoF pose estimation for the handheld device by processing the cropped image, metadata associated with the image, and first sensor data from one or more sensors associated with the handheld device using a second machine-learning model, generating a motion-sensor-based 6DoF pose estimation for the handheld device by integrating second sensor data from the one or more sensors associated with the handheld device, and generating a final 6DoF pose estimation for the handheld device based on the vision-based 6DoF pose estimation and the motion-sensor-based 6DoF pose estimation.

### TECHNICAL FIELD

This disclosure generally relates to artificial reality systems, and in particular, related to tracking a handheld device.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY OF PARTICULAR EMBODIMENTS

Particular embodiments described herein relate to systems and methods for enabling an artificial reality system to compute and track a handheld device’s six degrees of freedom (6DoF) pose using only an image captured by one or more cameras on a headset associated with the artificial reality system and sensor data from one or more sensors associated with the handheld device. In particular embodiments, the handheld device may be a controller associated with the artificial reality system. In particular embodiments, the one or more sensors associated with the handheld device may be an Inertial Measurement Unit (IMU) comprising one or more accelerometers, one or more gyroscopes, or one or more magnetometers. Legacy artificial reality systems track their associated controllers using a constellation of infrared light-emitting diodes (IR LEDs) embedded in the controllers. The LEDs may increase manufacturing cost, consume more power. Furthermore the LEDs may constrain a form factor of the controllers to accommodate the LEDs. For example, some legacy artificial reality systems have ring-shaped controllers, where the LEDs are placed on the ring. The invention disclosed herein may allow an artificial reality system to track a handheld device that does not have the LEDs.

In particular embodiments, a computing device may access an image comprising a hand or a user and/or a handheld device. In particular embodiments, the handheld device may be a controller for an artificial reality system. The image may be captured by one or more cameras associated with the computing device. In particular embodiments, the one or more cameras may be attached to a headset. The computing device may generate a cropped image that comprises a hand of a user or the handheld device from the image by processing the image using a first machine-learning model. The computing device may generate a vision-based 6DoF pose estimation for the handheld device by processing the cropped image, metadata associated with the image, and first sensor data from one or more sensors associated with the handheld device using a second machine-learning model. The second machine-learning model may also generate a vision-based-estimation confidence score corresponding to the generated vision-based 6DoF pose estimation. The metadata associated with the image may comprise intrinsic and extrinsic parameters associated with a camera that takes the image and canonical extrinsic and intrinsic parameters associated with an imaginary camera with a field-of-view that captures only the cropped image. In particular embodiments, the first sensor data may comprise a gravity vector estimate generated from a gyroscope. The second machine-learning model comprises a residual neural network (ResNet) backbone, a feature transform layer, and a pose regression layer. The feature transform layer may generate a feature map based on the cropped image. The pose regression layer may generate a number of three-dimensional keypoints of the handheld device and the vision-based 6DoF pose estimation. The computing device may generate a motion-sensor-based 6DoF pose estimation for the handheld device by integrating second sensor data from the one or more sensors associated with the handheld device. The motion-sensor-based 6DoF pose estimation may be generated by integrating N recently sampled IMU data. The computing device may also generate a motion-sensor-based-estimation confidence score corresponding to the motion-sensor-based 6DoF pose estimation. The computing device may generate a final 6DoF pose estimation for the handheld device based on the vision-based 6DoF pose estimation and the motion-sensor-based 6DoF pose estimation. The computing device may generate the final 6DoF pose estimation using an Extended Kalman Filter (EKF). The EKF may take a constrained 6DoF pose estimation as input when a combined confidence score calculated based on the vision-based-estimation confidence score and the motion-sensor-based-estimation confidence score is lower than a pre-determined threshold. The constrained 6DoF pose estimation may be inferred using heuristics based on the IMU data, human motion models, and context information associated with an application the handheld device is used for. The computing device may determine a fusion ratio between the vision-based 6DoF pose estimation and the motion-sensor-based 6DoF pose estimation based on the vision-based-estimation confidence score and the motion-sensor-based-estimation confidence score. In particular embodiments, a predicted pose from the EKF may be provided to the first machine-learning model as input.

In particular embodiments, the first machine-learning model and the second machine-learning model may be trained with annotated training data. The annotated training data may be created by an artificial reality system with LED-equipped handheld devices. The artificial reality system may utilize Simultaneous Localization And Mapping (SLAM) techniques for creating the annotated training data.

In particular embodiments, the handheld device may comprise one or more illumination sources that illuminate at a pre-determined interval. The pre-determined interval may be synchronized with an image taking interval. A blob detection module may detect one or more illuminations in the image. The blob detection module may determine a tentative location of the handheld device based on the detected one or more illuminations in the image. The blob detection module provides the tentative location of the handheld device to the first machine-learning model as input. In particular embodiments, the blob detection module may generate a tentative 6DoF pose estimation based on the detected one or more illuminations in the image. The blob detection module may provide the tentative 6DoF pose estimation to the second machine-learning model as input.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system.

FIG. 1B illustrates an example augmented reality system.

FIG. 2 illustrates an example logical architecture of an artificial reality system for tracking a handheld device.

FIG. 3 illustrates an example logical structure of a handheld device tracking component.

FIG. 4 illustrates an example logical structure of a handheld device tracking component with a blob detection module.

FIG. 5 illustrates an example method for tracking a handheld device’s 6DoF pose using an image and sensor data.

FIG. 6 illustrates an example computer system.

### DESCRIPTION OF EXAMPLE EMBODIMENTS

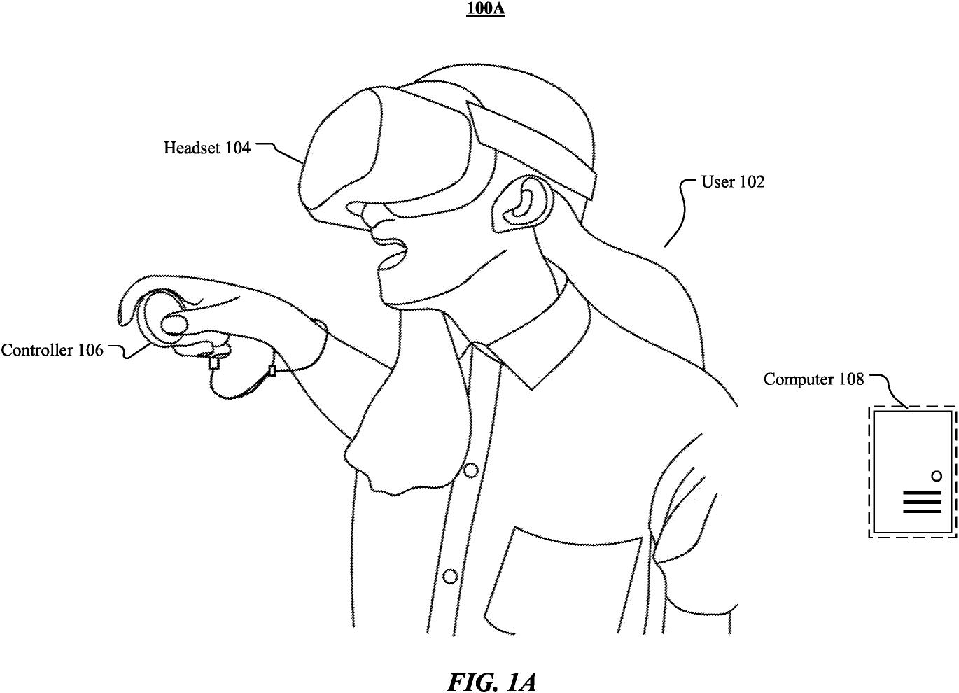

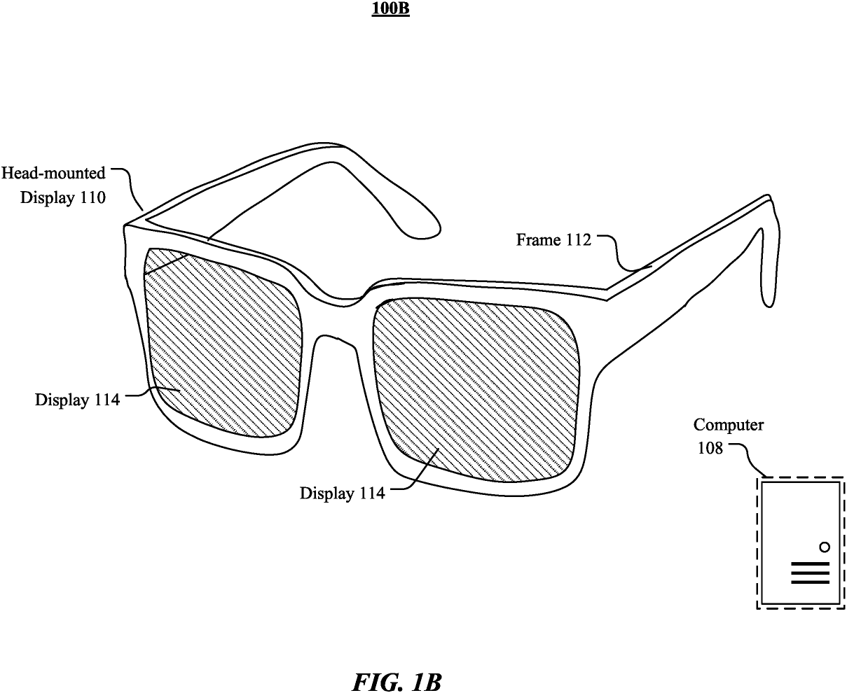

FIG. 1A illustrates an example artificial reality system 100A. In particular embodiments, the artificial reality system 100A may comprise a headset 104, a controller 106, and a computing device 108. A user 102 may wear the headset 104 that may display visual artificial reality content to the user 102. The headset 104 may include an audio device that may provide audio artificial reality content to the user 102. The headset 104 may include one or more cameras which can capture images and videos of environments. The headset 104 may include an eye tracking system to determine the vergence distance of the user 102. The headset 104 may include a microphone to capture voice input from the user 102. The headset 104 may be referred as a head-mounted display (HMD). The controller 106 may comprise a trackpad and one or more buttons. The controller 106 may receive inputs from the user 102 and relay the inputs to the computing device 108. The controller 106 may also provide haptic feedback to the user 102. The computing device 108 may be connected to the headset 104 and the controller 106 through cables or wireless connections. The computing device 108 may control the headset 104 and the controller 106 to provide the artificial reality content to and receive inputs from the user 102. The computing device 108 may be a standalone host computing device, an on-board computing device integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., glasses) comprising a frame 112, one or more displays 114, and a computing device 108. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The HMD 110 may include a microphone to capture voice input from the user. The augmented reality system 100B may further include a controller comprising a trackpad and one or more buttons. The controller may receive inputs from users and relay the inputs to the computing device 108. The controller may also provide haptic feedback to users. The computing device 108 may be connected to the HMD 110 and the controller through cables or wireless connections. The computing device 108 may control the HMD 110 and the controller to provide the augmented reality content to and receive inputs from users. The computing device 108 may be a standalone host computer device, an on-board computer device integrated with the HMD 110, a mobile device, or any other hardware platform capable of providing artificial reality content to and receiving inputs from users.

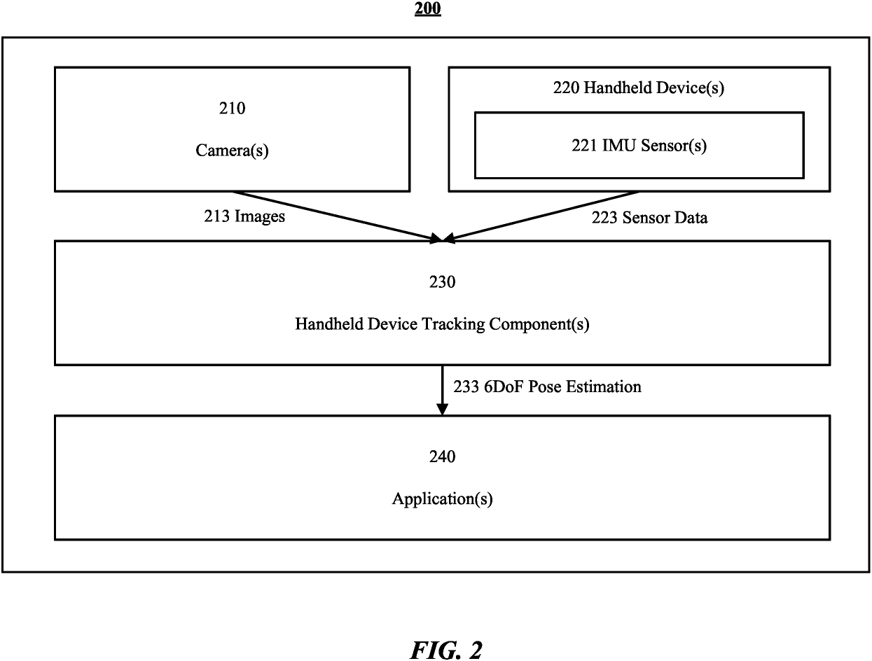

FIG. 2 illustrates an example logical architecture of an artificial reality system for tracking a handheld device. One or more handheld device tracking components 230 in an artificial reality system 200 may receive images 213 from one or more cameras 210 associated with the artificial reality system 200. The one or more handheld device tracking components 230 may also receive sensor data 223 from one or more handheld devices 220. The sensor data 223 may be captured by one or more IMU sensors 221 associated with the one or more handheld devices 220. The one or more handheld device tracking components 230 may generates 6DoF pose estimation 233 for each of the one or more handheld devices 220 based on the received images 213 and the sensor data 223. The generated 6DoF pose estimation may be a pose estimation relative to a particular point in a three-dimensional space. In particular embodiments, the particular point may be a particular point on a headset associated with the artificial reality system 200. In particular embodiments, the particular point may be a location of a camera that takes the images 213. In particular embodiments, the particular point may be any suitable point in the three-dimensional space. The generated 6DoF pose estimation 233 may be provided to one or more applications 240 running on the artificial reality system 200 as user input. The one or more applications 240 may interpret user’s intention based on the received 6DoF pose estimation of the one or more handheld devices 220. Although this disclosure describes a particular logical architecture of an artificial reality system, this disclosure contemplates any suitable logical architecture of an artificial reality system.

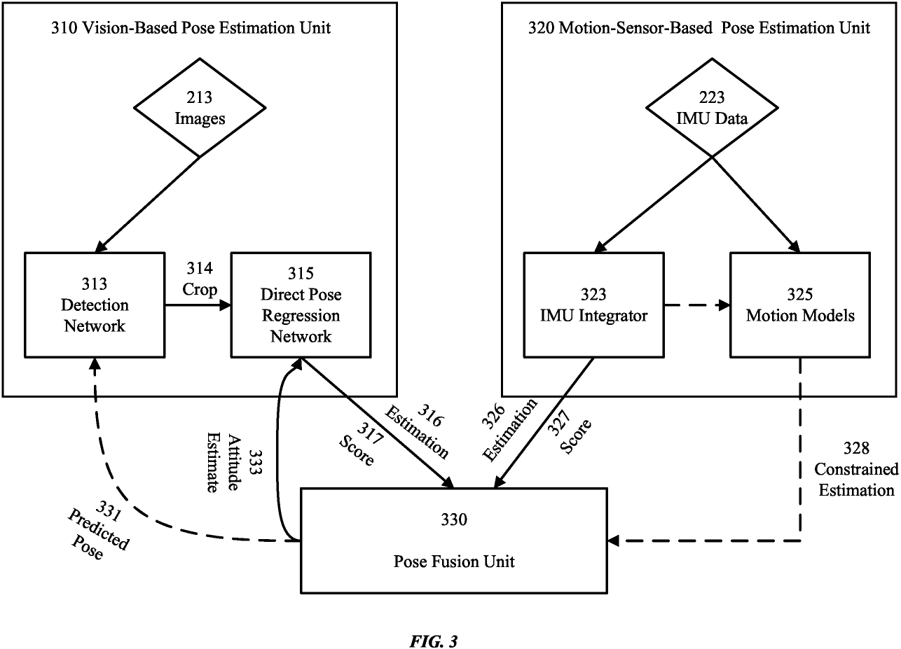

In particular embodiments, a computing device 108 may access an image 213 comprising a hand of a user and/or a handheld device. In particular embodiments, the handheld device may be a controller 106 for an artificial reality system 100A. The image may be captured by one or more cameras associated with the computing device 108. In particular embodiments, the one or more cameras may be attached to a headset 104. Although this disclosure describes a computing device associated with an artificial reality system 100A, this disclosure contemplates a computing device associated with any suitable system associated with one or more handheld devices. FIG. 3 illustrates an example logical structure of a handheld device tracking component 230. As an example and not by way of limitation, illustrated in FIG. 3, a handheld device tracking component 230 may comprise a vision-based pose estimation unit 310, a motion-sensor-based pose estimation unit 320, and a pose fusion unit 330. A first machine-learning model 313 may receive images 213 at a pre-determined interval from one or more cameras 210. The first machine-learning model 313 may be referred to as a detection network. In particular embodiments, the one or more cameras 210 may take pictures of a hand of a user or a handheld device at a pre-determined interval and provide the images 213 to the first machine-learning model 313. For example, the one or more cameras 210 may provide images to the first machine-learning model 30 times per second. In particular embodiments, the one or more cameras 210 may be attached to a headset 104. In particular embodiments, the handheld device may be a controller 106. Although this disclosure describes accessing an image of a hand of a user or a handheld device in a particular manner, this disclosure contemplates accessing an image of a hand of a user or a handheld device in any suitable manner.

In particular embodiments, the computing device 108 may generate a cropped image that comprises a hand of a user and/or the handheld device from the image 213 by processing the image 213 using a first machine-learning model 313. As an example and not by way of limitation, continuing with a prior example illustrated in FIG. 3, the first machine-learning model 313 may process the received image 213 along with additional information to generate a cropped image 314. The cropped image 314 may comprise a hand of a user holding the handheld device and/or a handheld device. The cropped image 314 may be provided to a second machine-learning model 315. The second machine-learning model 315 may be referred to as a direct pose regression network. Although this disclosure describes generating a cropped image out of an input image in a particular manner, this disclosure contemplates generating a cropped image out of an input image in any suitable manner.

In particular embodiments, the computing device 108 may generate a vision-based 6DoF pose estimation for the handheld device by processing the cropped image 314, metadata associated with the image, and first sensor data from one or more sensors associated with the handheld device using a second machine-learning model. The second machine-learning model may be referred to as a direct pose regression network. The second machine-learning model may also generate a vision-based-estimation confidence score corresponding to the generated vision-based 6DoF pose estimation. As an example and not by way of limitation, continuing with a prior example illustrated in FIG. 3, the second machine-learning model 315 of the vision-based pose estimation unit 310 may receive a cropped image 314 from the first machine-learning model 313. The second machine-learning model 315 may also access metadata associated with the image 213 and first sensor data from the one or more IMU sensor 221 associated with the handheld device 220. In particular embodiments, the metadata associated with the image 213 may comprise intrinsic and extrinsic parameters associated with a camera that takes the image 213 and canonical extrinsic and intrinsic parameters associated with an imaginary camera with a field-of-view that captures only the cropped image 314. Intrinsic parameters of a camera may be internal and fixed parameters to the camera. Intrinsic parameters may allow a mapping between camera coordinates and pixel coordinates in the image. Extrinsic parameters of a camera may be external parameters that may change with respect to the world frame. Extrinsic parameters may define a location and orientation of the camera with respect to the world. In particular embodiments, the first sensor data may comprise a gravity vector estimate generated from a gyroscope. FIG. 3 does not illustrate the metadata and the first sensor data for the simplicity. The metadata and the first sensor data may be optional input to the second machine-learning model 315. The second machine-learning model 315 may generate a vision-based 6DoF pose estimation 316 and a vision-based-estimation confidence score 317 corresponding to the generated vision-based 6DoF pose estimation by processing the cropped image 314. In particular embodiments, the second machine-learning model 315 may also process the metadata and the first sensor data to generate the vision-based 6DoF pose estimation 316 and the vision-based-estimation confidence score 317. Although this disclosure describes generating a vision-based 6DoF pose estimation in a particular manner, this disclosure contemplates generating a vision-based 6DoF pose estimation in any suitable manner.

In particular embodiments, the second machine-learning model 315 may comprise a ResNet backbone, a feature transform layer, and a pose regression layer. The feature transform layer may generate a feature map based on the cropped image 314. The pose regression layer may generate a number of three-dimensional keypoints of the handheld device and the vision-based 6DoF pose estimation 316. The pose regression layer may also generate a vision-based-estimation confidence score 317 corresponding to the vision-based 6DoF pose estimation 316. Although this disclosure describes a particular architecture for the second machine-learning model, this disclosure contemplates any suitable architecture for the second machine-learning model.

In particular embodiments, the computing device 108 may generate a motion-sensor-based 6DoF pose estimation for the handheld device by integrating second sensor data from the one or more sensors associated with the handheld device. The motion-sensor-based 6DoF pose estimation may be generated by integrating N recently sampled IMU data. The computing device 108 may also generate a motion-sensor-based-estimation confidence score corresponding to the motion-sensor-based 6DoF pose estimation. As an example and not by way of limitation, continuing with a prior example illustrated in FIG. 3, the handheld device tracking component 230 may receive second sensor data 223 from each of the one or more handheld devices 220. The second sensor data 223 may be captured by the one or more IMU sensors 221 associated with the handheld device 220 at a pre-determined interval. For example, the handheld device 220 may send the second sensor data 223 500 times per second to the handheld device tracking component 230. An IMU integrator module 323 in the motion-sensor-based pose estimation unit 320 may access the second sensor data 223. The IMU integrator module 323 may integrate N recently received second sensor data 223 to generate a motion-sensor-based 6DoF pose estimation 326 for the handheld device. The IMU integrator module 323 may also generate a motion-sensor-based-estimation confidence score 327 corresponding to the generated motion-sensor-based 6DoF pose estimation 326. Although this disclosure describes generating a motion-sensor-based pose estimation and its corresponding confidence score in a particular manner, this disclosure contemplates generating a motion-sensor-based pose estimation and its corresponding confidence score in any suitable manner.

In particular embodiments, the computing device 108 may generate a final 6DoF pose estimation for the handheld device based on the vision-based 6DoF pose estimation 316 and the motion-sensor-based 6DoF pose estimation 326. The computing device 108 may generate the final 6DoF pose estimation using an EKF. As an example and not by way of limitation, continuing with a prior example illustrated in FIG. 3, the pose fusion unit 330 may generate a final 6DoF pose estimation for the handheld device based on the vision-based 6DoF pose estimation 316 and the motion-sensor-based 6DoF pose estimation 326. The pose fusion unit 330 may comprise an EKF. Although this disclosure describes generating a final 6DoF pose estimation of a handheld device based on a vision-based 6DoF pose estimation and a motion-sensor-based 6DoF pose estimation in a particular manner, this disclosure contemplates generating a final 6DoF pose estimation of a handheld device based on a vision-based 6DoF pose estimation and a motion-sensor-based 6DoF pose estimation in any suitable manner.

In particular embodiments, the EKF may take a constrained 6DoF pose estimation as input when a combined confidence score calculated based on the vision-based-estimation confidence score 317 and the motion-sensor-based-estimation confidence score 327 is lower than a pre-determined threshold. In particular embodiments, the combined confidence score may be based only on the vision-based-estimation confidence score 317. In particular embodiments, the combined confidence score may be based only on the motion-sensor-based-estimation confidence score 327. The constrained 6DoF pose estimation may be inferred using heuristics based on the IMU data, human motion models, and context information associated with an application the handheld device is used for. As an example and not by way of limitation, continuing with a prior example illustrated in FIG. 3, one or more motion models 325 may be used to infer a constrained 6DoF pose estimation 328. In particular embodiments, the one or more motion models 325 may comprise a context-information-based motion model. An application the user is currently engaged with may be associated with a particular set of movements of the user. Based on the particular set of movements, a constrained 6DoF pose estimation 328 of the handheld device may be inferred based on recent k estimations. In particular embodiments, the one or more motion models 325 may comprise a human motion model. A motion of the user may be predicted based on the user’s previous movements. Based on the prediction along with other information, a constrained 6DoF pose estimation 328 may be generated. In particular embodiments, the one or more motion models 325 may comprise an IMU-data-based motion model. The IMU-data-based motion model may generate a constrained 6DoF pose estimation 328 based on the motion-sensor-based 6DoF pose estimation generated by the IMU integrator module 323. The IMU-data-based motion model may generate the constrained 6DoF pose estimation 328 further based on IMU sensor data. The pose fusion unit 330 may take the constrained 6DoF pose estimation 328 as input when a combined confidence score calculated based on the vision-based-estimation confidence score 317 and the motion-sensor-based-estimation confidence score 327 is lower than a pre-determined threshold. In particular embodiments, the combined confidence score may be determined based only on the vision-based-estimation confidence score 317. In particular embodiments, the combined confidence score may be determined based only on the motion-sensor-based-estimation confidence score 327. Although this disclosure describes generating a constrained 6DoF pose estimation and taking the generated constrained 6DoF pose estimation as input in a particular manner, this disclosure contemplates generating a constrained 6DoF pose estimation and taking the generated constrained 6DoF pose estimation as input in any suitable manner.

In particular embodiments, the computing device 108 may determine a fusion ratio between the vision-based 6DoF pose estimation and the motion-sensor-based 6DoF pose estimation based on the vision-based-estimation confidence score 317 and the motion-sensor-based-estimation confidence score 327. As an example and not by way of limitation, continuing with a prior example illustrated in FIG. 3, the pose fusion unit 330 may generate a final 6DoF pose estimation for the handheld device by fusing the vision-based 6DoF pose estimation 316 and the motion-sensor-based 6DoF pose estimation 326. The pose fusion unit 330 may determine a fusion ratio between the vision-based 6DoF pose estimation 316 and the motion-sensor-based 6DoF pose estimation 326 based on the vision-based-estimation confidence score 317 and the motion-sensor-based-estimation confidence score 327. In particular embodiments, the vision-based-estimation confidence score 317 may be high while the motion-sensor-based-estimation confidence score 327 may be low. In such a case, the pose fusion unit 330 may determine a fusion ratio such that the final 6DoF pose estimation may rely on the vision-based 6DoF pose estimation 316 more than the motion-sensor-based 6DoF pose estimation 326. In particular embodiments, the motion-sensor-based-estimation confidence score 327 may be high while the vision-based-estimation confidence score 317 may be low. In such a case, the pose fusion unit 330 may determine a fusion ratio such that the final 6DoF pose estimation may rely on the motion-sensor-based 6DoF pose estimation 326 more than the vision-based 6DoF pose estimation 316. Although this disclosure describes determining a fusion ratio between the vision-based 6DoF pose estimation and the motion-sensor-based 6DoF pose estimation in a particular manner, this disclosure contemplates determining a fusion ratio between the vision-based 6DoF pose estimation and the motion-sensor-based 6DoF pose estimation in any suitable manner.

In particular embodiments, a predicted pose from the EKF may be provided to the first machine-learning model as input. In particular embodiments, an estimated attitude from the EKF may be provided to the second machine-learning model as input. As an example and not by way of limitation, continuing with a prior example illustrated in FIG. 3, the pose fusion unit 330 may provide a predicted pose 331 of the handheld device to the first machine-learning model 313. The first machine-learning model 313 may use the predicted pose 331 to determine a location of the handheld device in the following image. In particular embodiments, the pose fusion unit 330 may provide an estimated attitude 333 to the second machine-learning model 315. The second machine-learning model 315 may use the estimated attitude 333 to estimate the following vision-based 6DoF pose estimation 316. Although this disclosure describes providing additional input to the machine-learning models by the pose fusion unit in a particular manner, this disclosure contemplates providing additional input to the machine-learning models by the pose fusion unit in any suitable manner.

In particular embodiments, the first machine-learning model and the second machine-learning model may be trained with annotated training data. The annotated training data may be created by a second artificial reality system with LED-equipped handheld devices. The second artificial reality system may utilize SLAM techniques for creating the annotated training data. As an example and not by way of limitation, a second artificial reality system with LED-equipped handheld devices may be used for generating annotated training data. The LEDs on the handheld devices may be turned on at a pre-determined interval. One or more cameras associated with the second artificial reality system may capture images of the handheld devices at exact time when the LEDs are turned on with a special exposure level such that the LEDs standout in the images. In particular embodiments, the special exposure level may be lower than a normal exposure level such that the captured images are darker than normal images. Based on the visible LEDs in the images, the second artificial reality system may be able to compute a 6DoF pose estimation for each of the handheld devices using SLAM techniques. The computed 6DoF pose estimation for each captured image may be used as an annotation for the image while the first machine-learning model and the second machine-learning model are being trained. Generating annotated training data may significantly reduce a need for manual annotations. Although this disclosure describes generating annotated training data for training the first machine-learning model and the second machine-learning model in a particular manner, this disclosure contemplates generating annotated training data for training the first machine-learning model and the second machine-learning model in any suitable manner.

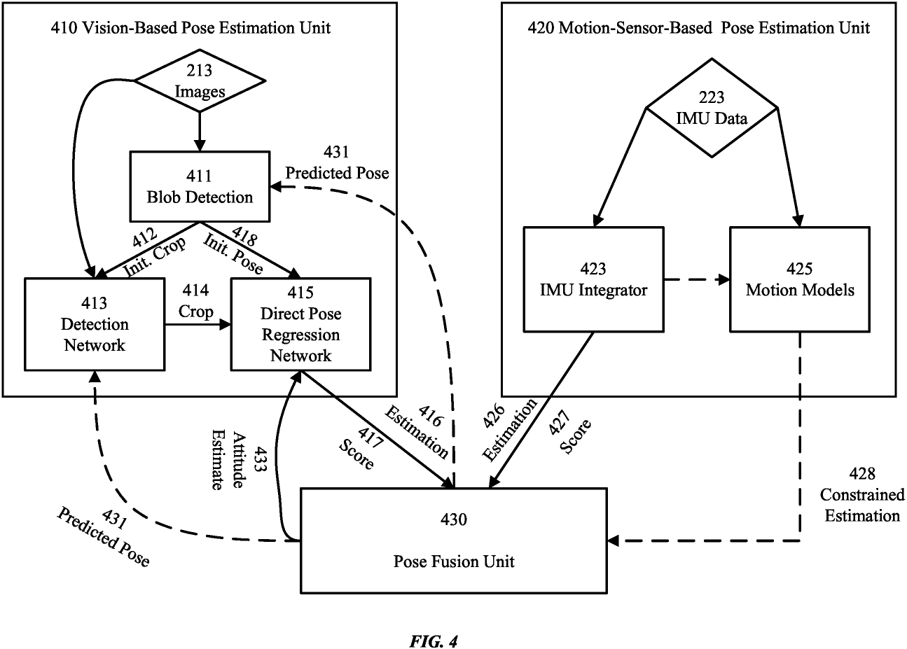

In particular embodiments, the handheld device 220 may comprise one or more illumination sources that illuminate at a pre-determined interval. In particular embodiments, the one or more illumination sources may comprise LEDs, light pipes, or any suitable illumination sources. The pre-determined interval may be synchronized with an image taking interval at the one or more cameras 210. Thus, the one or more cameras 210 may capture images of the handheld device 220 exactly at the same time when the one or more illumination sources illuminate. A blob detection module may detect one or more illuminations in the image. The blob detection module may determine a tentative location of the handheld device based on the detected one or more illuminations in the image. The blob detection module may provide the tentative location of the handheld device to the first machine-learning model as input. In particular embodiments, the blob detection module may provide an initial crop image comprising the handheld device to the first machine-learning model as input. FIG. 4 illustrates an example logical structure of a handheld device tracking component with a blob detection module. As an example and not by way of limitation, illustrated in FIG. 4, the handheld device tracking component 230 may comprise a vision-based pose estimation unit 410, a motion-sensor-based pose estimation unit 420, and a pose fusion unit 430. The vision-based pose estimation unit 410 may receive images 213 comprising a handheld device with illuminating sources. Because the images 213 are captured at the same time when the illuminating sources illuminate, the images 213 may comprise areas that are brighter than the other areas. The vision-based pose estimation unit 410 may comprise a blob detection module 411. The blob detection module 411 may detect those bright areas in the image 213 that help the blob detection module 411 to determine a tentative location of the handheld device and/or a tentative pose of the handheld device. The detected bright areas may be referred to as detected illuminations. The blob detection module 411 may provide the tentative location of the handheld device to a first machine-learning model 413, also known as a detection network, as input. In particular embodiments, the blob detection module 411 may provide an initial crop image 412 comprising the handheld device to the first machine-learning model 413 as input. The first machine-learning model 413 may generate a cropped image 414 of the handheld device based on the image 213 and the received initial crop image 412. The first machine-learning model 413 may provide the cropped image 414 to a second machine-learning model 415, also known as a direct pose regression network. Although this disclosure describes providing an initial crop image comprising a handheld device in a particular manner, this disclosure contemplates providing an initial crop image comprising a handheld device in any suitable manner.

In particular embodiments, the blob detection module 411 may generate a tentative 6DoF pose estimation based on the detected one or more bright areas in the image 213. The blob detection module 411 may provide the tentative 6DoF pose estimation to the second machine-learning model 415 as input. As an example and not by way of limitation, continuing with a prior example illustrated in FIG. 4, the blob detection module 411 may generate an initial 6DoF pose estimation 418 of the handheld device based on the detected one or more illuminations in the image 213. The blob detection module 411 may provide the initial 6DoF pose estimation 418 to the second machine-learning model 415. The second machine-learning model 415 may generate a vision-based 6DoF pose estimation 416 by processing the cropped image 414 and the initial 6DoF pose estimation 418 along with other available input data. The second machine-learning model 415 may also generate a vision-based-estimation confidence score 417 corresponding to the generated vision-based 6DoF pose estimation 416. The second machine-learning model 415 may provide the generated vision-based 6DoF pose estimation 416 to the pose fusion unit 430. The second machine-learning model 415 may provide the generated vision-based-estimation confidence score 417 to the pose fusion unit 430. Although this disclosure describes providing an initial 6DoF pose estimation to the second machine-learning model in a particular manner, this disclosure contemplates providing an initial 6DoF pose estimation to the second machine-learning model in any suitable manner.

In particular embodiments, the computing device 108 may generate a motion-sensor-based 6DoF pose estimation for the handheld device by integrating second sensor data from the one or more sensors associated with the handheld device. The computing device 108 may also generate a motion-sensor-based-estimation confidence score corresponding to the motion-sensor-based 6DoF pose estimation. As an example and not by way of limitation, continuing with a prior example illustrated in FIG. 4, the handheld device tracking component 230 may receive second sensor data 223 from each of the one or more handheld devices 220. An IMU integrator module 423 in the motion-sensor-based pose estimation unit 420 may access the second sensor data 223. The IMU integrator module 423 may integrate N recently received second sensor data 223 to generate a motion-sensor-based 6DoF pose estimation 426 for the handheld device. The IMU integrator module 423 may also generate a motion-sensor-based-estimation confidence score 427 corresponding to the generated motion-sensor-based 6DoF pose estimation 426. Although this disclosure describes generating a motion-sensor-based pose estimation and its corresponding confidence score in a particular manner, this disclosure contemplates generating a motion-sensor-based pose estimation and its corresponding confidence score in any suitable manner.

In particular embodiments, the computing device 108 may generate a final 6DoF pose estimation for the handheld device based on the vision-based 6DoF pose estimation 416 and the motion-sensor-based 6DoF pose estimation 426. The computing device 108 may generate the final 6DoF pose estimation using an EKF. As an example and not by way of limitation, continuing with a prior example illustrated in FIG. 4, the pose fusion unit 430 may generate a final 6DoF pose estimation for the handheld device based on the vision-based 6DoF pose estimation 416 and the motion-sensor-based 6DoF pose estimation 426. The pose fusion unit 430 may comprise an EKF. Although this disclosure describes generating a final 6DoF pose estimation of a handheld device based on a vision-based 6DoF pose estimation and a motion-sensor-based 6DoF pose estimation in a particular manner, this disclosure contemplates generating a final 6DoF pose estimation of a handheld device based on a vision-based 6DoF pose estimation and a motion-sensor-based 6DoF pose estimation in any suitable manner.

In particular embodiments, the EKF may take a constrained 6DoF pose estimation as input when a combined confidence score calculated based on the vision-based-estimation confidence score 417 and the motion-sensor-based-estimation confidence score 427 is lower than a pre-determined threshold. In particular embodiments, the combined confidence score may be based only on the vision-based-estimation confidence score 417. In particular embodiments, the combined confidence score may be based only on the motion-sensor-based-estimation confidence score 427. The constrained 6DoF pose estimation may be inferred using heuristics based on the IMU data, human motion models, and context information associated with an application the handheld device is used for. As an example and not by way of limitation, continuing with a prior example illustrated in FIG. 4, one or more motion models 425 may be used to infer a constrained 6DoF pose estimation 428 like the one or more motion models 325 in FIG. 3. The pose fusion unit 430 may take the constrained 6DoF pose estimation 428 as input when a combined confidence score calculated based on the vision-based-estimation confidence score 417 and the motion-sensor-based-estimation confidence score 427 is lower than a pre-determined threshold. In particular embodiments, the combined confidence score may be determined based only on the vision-based-estimation confidence score 417. In particular embodiments, the combined confidence score may be determined based only on the motion-sensor-based-estimation confidence score 427. Although this disclosure describes generating a constrained 6DoF pose estimation and taking the generated constrained 6DoF pose estimation as input in a particular manner, this disclosure contemplates generating a constrained 6DoF pose estimation and taking the generated constrained 6DoF pose estimation as input in any suitable manner.

In particular embodiments, a predicted pose from the pose fusion unit 430 may be provided to the blob detection module 411 as input. In particular embodiments, a predicted pose from the pose fusion unit 430 may be provided to the first machine-learning model 413 as input. In particular embodiments, an estimated attitude from the pose fusion unit 430 may be provided to the second machine-learning model as input. As an example and not by way of limitation, continuing with a prior example illustrated in FIG. 4, the pose fusion unit 430 may provide a predicted pose 431 to the blob detection module 411. The blob detection module 411 may use the received predicted pose 431 to determine a tentative location of the handheld device and/or a tentative 6DoF pose estimation of the handheld device in the following image. In particular embodiments, the pose fusion unit 430 may provide a predicted pose 431 of the handheld device to the first machine-learning model 413. The first machine-learning model 413 may use the predicted pose 431 to determine a location of the handheld device in the following image. In particular embodiments, the pose fusion unit 430 may provide an estimated attitude 433 to the second machine-learning model 415. The second machine-learning model 415 may use the estimated attitude 433 to estimate the following vision-based 6DoF pose estimation 316. Although this disclosure describes providing additional input to the blob detection module and the machine-learning models by the pose fusion unit in a particular manner, this disclosure contemplates providing additional input to the blob detection module and the machine-learning models by the pose fusion unit in any suitable manner.

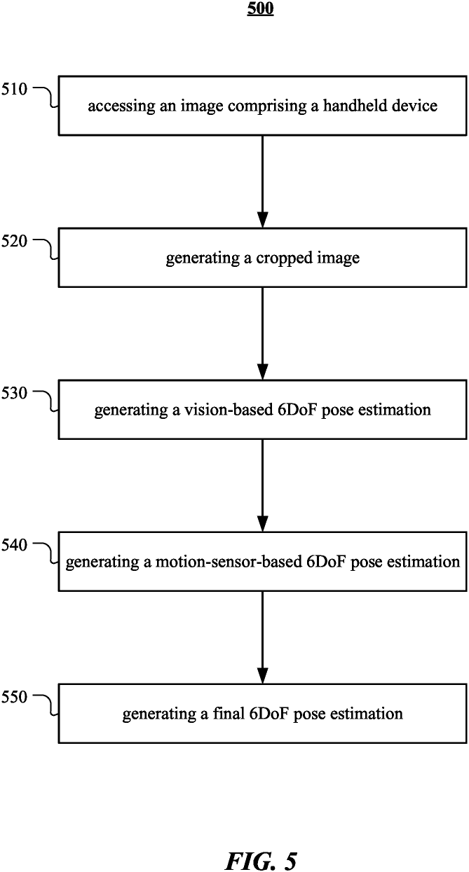

FIG. 5 illustrates an example method 500 for tracking a handheld device’s 6DoF pose using an image and sensor data. The method may begin at step 510, where the computing device 108 may access an image comprising a handheld device. The image may be captured by one or more cameras associated with the computing device 108. At step 520, the computing device 108 may generate a cropped image that comprises a hand of a user or the handheld device from the image by processing the image using a first machine-learning model. At step 530, the computing device 108 may generate a vision-based 6DoF pose estimation for the handheld device by processing the cropped image, metadata associated with the image, and first sensor data from one or more sensors associated with the handheld device using a second machine-learning model. At step 540, the computing device 108 may generate a motion-sensor-based 6DoF pose estimation for the handheld device by integrating second sensor data from the one or more sensors associated with the handheld device. At step 550, the computing device 108 may generate a final 6DoF pose estimation for the handheld device based on the vision-based 6DoF pose estimation and the motion-sensor-based 6DoF pose estimation. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for tracking a handheld device’s 6DoF pose using an image and sensor data including the particular steps of the method of FIG. 5, this disclosure contemplates any suitable method for tracking a handheld device’s 6DoF pose using an image and sensor data including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

### Systems and Methods

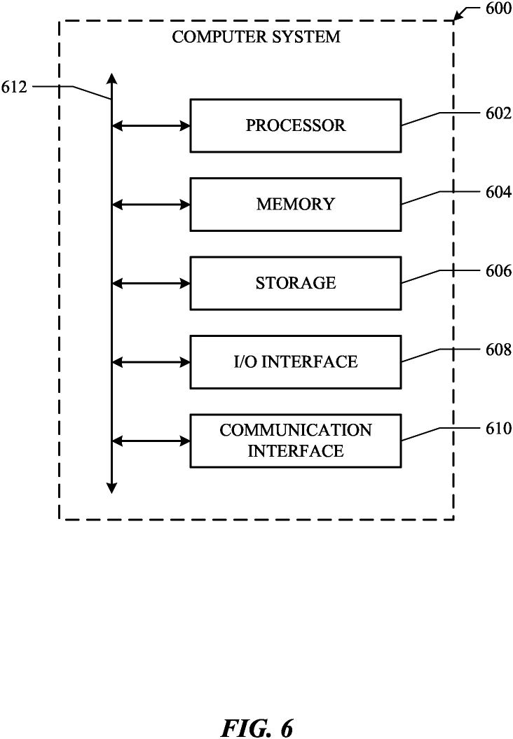

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing device:
accessing an image comprising a handheld device, wherein the image is captured by one or more cameras associated with the computing device;
generating a cropped image that comprises a hand of a user or the handheld device from the image by processing the image using a first machine-learning model;
generating a vision-based six degrees of freedom (6DoF) pose estimation for the handheld device by processing the cropped image, metadata associated with the image, and first sensor data from one or more sensors associated with the handheld device using a second machine-learning model;
generating a motion-sensor-based 6DoF pose estimation for the handheld device by integrating second sensor data from the one or more sensors associated with the handheld device; and
generating a final 6DoF pose estimation for the handheld device based on the vision-based 6DoF pose estimation and the motion-sensor-based 6DoF pose estimation.

2. The method of claim 1, wherein the second machine-learning model also generates a vision-based-estimation confidence score corresponding to the generated vision-based 6DoF pose estimation.

3. The method of claim 2, wherein the motion-sensor-based 6DoF pose estimation is generated by integrating N recently sampled Inertial Measurement Unit (IMU) data, and wherein a motion-sensor-based-estimation confidence score corresponding to the motion-sensor-based 6DoF pose estimation is generated.

4. The method of claim 3, wherein generating the final 6DoF pose estimation comprises using an Extended Kalman Filter (EKF).

5. The method of claim 4, wherein the EKF takes a constrained 6DoF pose estimation as input when a combined confidence score calculated based on the vision-based-estimation confidence score and the motion-sensor-based-estimation confidence score is lower than a pre-determined threshold.

6. The method of claim 5, wherein the constrained 6DoF pose estimation is inferred using heuristics based on the IMU data, human motion models, and context information associated with an application the handheld device is used for.

7. The method of claim 4, wherein a fusion ratio between the vision-based 6DoF pose estimation and the motion-sensor-based 6DoF pose estimation is determined based on the vision-based-estimation confidence score and the motion-sensor-based-estimation confidence score.

8. The method of claim 4, wherein a predicted pose from the EKF is provided to the first machine-learning model as input.

9. The method of claim 1, wherein the handheld device is a controller for an artificial reality system.

10. The method of claim 1, the metadata associated with the image comprises intrinsic and extrinsic parameters associated with a camera that takes the image and canonical extrinsic and intrinsic parameters associated with an imaginary camera with a field-of-view that captures only the cropped image.

11. The method of claim 1, wherein the first sensor data comprises a gravity vector estimate generated from a gyroscope.

12. The method of claim 1, wherein the first machine-learning model and the second machine-learning model are trained with annotated training data, wherein the annotated training data is created by an artificial reality system with LED-equipped handheld devices, and wherein the artificial reality system utilizes Simultaneous Localization And Mapping (SLAM) techniques for creating the annotated training data.

13. The method of claim 1, wherein the second machine-learning model comprises a residual neural network (ResNet) backbone, a feature transform layer, and a pose regression layer.

14. The method of claim 13, wherein the pose regression layer generates a number of three-dimensional keypoints of the handheld device and the vision-based 6DoF pose estimation.

15. The method of claim 1, wherein the handheld device comprises one or more illumination sources that illuminate at a pre-determined interval, wherein the pre-determined interval is synchronized with an image taking interval.

16. The method of claim 15, wherein a blob detection module detects one or more illuminations in the image.

17. The method of claim 16, wherein the blob detection module determines a tentative location of the handheld device based on the detected one or more illuminations in the image, and wherein the blob detection module provides the tentative location of the handheld device to the first machine-learning model as input.

18. The method of claim 16, wherein the blob detection module generates a tentative 6DoF pose estimation based on the detected one or more illuminations in the image, and wherein the blob detection module provides the tentative 6DoF pose estimation to the second machine-learning model as input.

19. One or more computer-readable non-transitory storage media embodying software that is operable when executed to:
access an image comprising a handheld device, wherein the image is captured by one or more cameras associated with the computing device;
generate a cropped image that comprises a hand of a user or the handheld device from the image by processing the image using a first machine-learning model;
generate a vision-based six degrees of freedom (6DoF) pose estimation for the handheld device by processing the cropped image, metadata associated with the image, and first sensor data from one or more sensors associated with the handheld device using a second machine-learning model;
generate a motion-sensor-based 6DoF pose estimation for the handheld device by integrating second sensor data from the one or more sensors associated with the handheld device; and
generate a final 6DoF pose estimation for the handheld device based on the vision-based 6DoF pose estimation and the motion-sensor-based 6DoF pose estimation.

20. A system comprising: one or more processors; and a non-transitory memory coupled to the processors comprising instructions executable by the processors, the processors operable when executing the instructions to:
access an image comprising a handheld device, wherein the image is captured by one or more cameras associated with the computing device;
generate a cropped image that comprises a hand of a user or the handheld device from the image by processing the image using a first machine-learning model;
generate a vision-based six degrees of freedom (6DoF) pose estimation for the handheld device by processing the cropped image, metadata associated with the image, and first sensor data from one or more sensors associated with the handheld device using a second machine-learning model;
generate a motion-sensor-based 6DoF pose estimation for the handheld device by integrating second sensor data from the one or more sensors associated with the handheld device; and
generate a final 6DoF pose estimation for the handheld device based on the vision-based 6DoF pose estimation and the motion-sensor-based 6DoF pose estimation.
